(19) United States
(12) Patent Application Publication
(10) Pub. No.: US 2025/0212881 A1
(43) Pub. Date: Jul. 3, 2025

(54) AN AGROCHEMICAL COMPOSITION

(71) Applicant: UPL LIMITED, Mumbai (IN)

(72) Inventors: Popat Ganesh CHAVAN, Mumbai (IN); Dev Varta MUKHERJEE, Mumbai (IN); Rajan Ramakant SHIRSHAT, Mumbai (IN)

(21) Appl. No.: 18/848,705

(22) PCT Filed: Mar. 21, 2023
(86) PCT No.: PCT/IB2023/052736

§ 371 Date: Sep. 19, 2024

(30) Foreign Application Priority Data
Mar. 22, 2022 (IN) 202221015733

(51) Int. Cl. A01N 43/56; A01N 25/14; A01N 25/30; A01N 43/653; A01N 47/10; A01P 3/00

(52) U.S. Cl. CPC A01N 43/56; A01N 25/14; A01N 25/30; A01N 43/653; A01N 47/10; A01P 3/00

(57) ABSTRACT

The present invention relates to agrochemical compositions of pyrazolecarboxamide fungicide and its combinations. The invention further relates to a method of controlling phytopathogenic diseases by applying said compositions to the plants or to their locus thereof.

### FIELD OF THE INVENTION

The present invention relates to an agrochemical composition comprising a pyrazolecarboxamide fungicide. The present invention more particularly relates to an agrochemical composition comprising a pyrazolecarboxamide fungicide and its combinations in the form of water dispersible granules (WDGs).

### BACKGROUND OF THE INVENTION

Based on the physicochemical properties and the desired biological action, agrochemical active ingredients have been formulated as emulsifiable concentrates (EC), as soluble liquid (SL) formulations and/or as oil-based suspension concentrates (OD) or as solid formulations such as water dispersible granules (WDG). In an EC formulation and in a SL formulation, the active compound is present in dissolved form; in an OD formulation, the active compound is present as a dispersed solid. In a WDG formulation, the solid active is present along with other emulsifiers and inert ingredients. Agrochemical formulations are commonly applied by spraying and in meeting the demand for a reduction in the risk to the end user, solid formulations are attractive because the active agrochemical is immobilised.

Widely acceptable granular formulations, WDGs are wettable powders that have been aggregated into uniform granule size for easier handling and to eliminate respirable particles. They are dispersed in the spray tank and applied as dilute suspensions in the same way as wettable powders. WDGs incorporate the same ingredients as wettable powders, including dispersants and clay, although generally with a higher level of active and less diluent. The granules must be strong enough to resist crumbling into powder, yet readily and completely disintegrate and disperse in the spray tank. This avoids nozzle clogging and ensures the finest particle size of the active ingredient for optimum efficacy.

Chemically, pyrazole carboxamide compounds are succinate dehydrogenase inhibitors (SDHIs) known for preventive, curative and systemic controlling effects on plant microbes. The enzyme succinate dehydrogenase is linked to the inner mitochondrial membrane that participates in the cellular respiration process. Inhibitors of succinate dehydrogenase enzyme are used as fungicides in the agricultural field and are known for their high level of biological activity and broad-spectrum action. Pyrazole carboxamide compounds are active substances used in fungicidal products to control certain fungi and moulds affecting crops. Fluindapyr is a pyrazolecarboxamide compound belonging to the class of N-indanyl-pyrazolecarboxamides and is represented by formula (I), shown below:

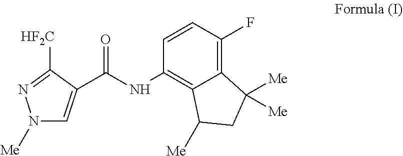

Numerous formulations containing pyrazolecarboxamides are known in the art for use in the agrochemical field. Such formulations can be in the form of solid or liquid preparations, or in the form of solid suspensions in liquids. To be correctly used, the formulations have to be able to solubilize or disperse, or they have to give rise to stable emulsions when diluted in specific volumes of water. The formulations with the addition of water are in turn applied to crops or to soil in which a crop is grown, before or after sowing or germination.

Unlike other types of formulations, the water dispersible granules can have physical instability problems over time due to the phenomenon of causing suspensibility drop, disintegration issues, dispersibility problem which in turn downgrade the performance of the formulation during application of fluindapyr-based formulations.

It becomes further challenging when multiple active ingredients are to be combined into a single system. For instance, water dispersible granules of multiple active ingredients require a fine balance between suspensibility and dispersibility of individual actives to achieve the desired performance. Moreover, each active ingredient needs to preserve its own identity without being degraded much due to presence of diverse chemical forces within the system.

To broaden the spectrum of activity one or more fungicides may be combined in the form of a granular composition for e.g., a conazole fungicide, Prothioconazole, having the IUPAC name 2-[2-(1-chlorocyclopropyl)-3-(2-chlorophenyl)-2-hydroxypropyl]-2,4-dihydro-1,2,4-triazole-3-thione, has the following structural formula (II):

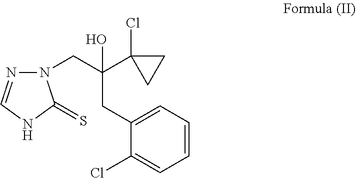 [SMILES: OC(Cc1ccccc1Cl)(Cn1nc[nH]c1=S)C1(Cl)CC1]

Prothioconazole is a synthetic compound of the triazole family of compounds, which are a class of systemic fungicides that on contact with the plant enter it and spread from the site of application to untreated or newly grown area, uprooting existing fungi and/or protecting the plant from future fungal infestations. The mechanism of action of prothioconazole is due to its ability to interfere with the biosynthesis of biosteroids or to inhibit the biosynthesis of ergosterol. Ergosterol is needed by the fungus for membrane structure and function and is essential for the development of functional cell walls. The application of prothioconazole results in abnormal fungal growth and eventually in death.

Furthermore, mancozeb is a dithiocarbamate fungicide and is a zinc ion coordination product with manganese ethylene-1,2-bisdithiocarbamate polymer, having the following chemical structure as formula (III):

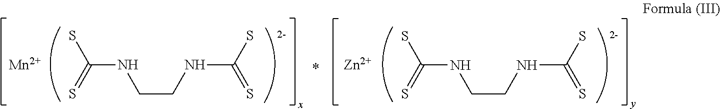

Mancozeb has a polymeric structure containing 1.6% zinc, in which 6% of the units are in the form of a coordination complex. Mancozeb is essentially inert to oxidation by atmospheric oxidation, in contrast with maneb. It is also essentially non-phytotoxic in contrast with maneb, zineb or mixtures of these which are harmful to number of plants. The standard composition of mancozeb available in the art is an 80% wettable powder containing 16% manganese and 2% zinc.

With an objective of broadening the spectrum of activity, combining active ingredients with diversified chemical classes is a common practice and at the same time, handling distinctive physico-chemical profile of individual active ingredients in a common system is challenging. Therefore, there is a need to develop a stable composition having good physico-chemical characteristics, such as homogeneity of the components, good suspensibility, good dispersibility, with these characteristics remaining stable over time.

### SUMMARY OF THE INVENTION

In an aspect of the present invention, an agrochemical composition comprises:
a) at least one pyrazolecarboxamide fungicide or a derivative thereof; and
b) at least two surfactants.

In another aspect of the present invention, an agrochemical composition comprises:
a) at least one pyrazolecarboxamide fungicide or a derivative thereof; and
b) at least two surfactants comprising aryl sulphonic acid salts or its derivatives.

In another aspect of the present invention, an agrochemical composition comprises:
a) at least one pyrazolecarboxamide fungicide or a derivative thereof;
b) at least one or more additional fungicide or a derivative thereof; and
c) at least two surfactants comprising aryl sulphonic acid salts or its derivatives thereof.

In another aspect of the present invention, an agrochemical composition comprises:
a) at least one pyrazolecarboxamide fungicide or a derivative thereof;
b) at least one or more additional fungicide selected from the group comprising dithiocarbamate, conazole, benzimidazole, strobilurins and a copper group of fungicides or a derivative thereof; and
c) at least two surfactants comprising aryl sulphonic acid salts or its derivatives thereof.

In another aspect of the present invention, an agrochemical composition comprises:
a) at least one pyrazolecarboxamide fungicide or a derivative thereof;
b) at least one or more additional fungicides selected from the group comprising dithiocarbamate and conazole fungicides; and
c) at least two surfactants comprising aryl sulphonic acid salts or its derivatives thereof.

In another aspect of the present invention, there is provided a method of controlling phytopathogenic fungal diseases by applying to the plants or to their locus or to plant propagation material, an agrochemical composition comprising: (a) at least one pyrazolecarboxamide fungicide or a derivative thereof; and (b) at least two surfactants comprising aryl sulphonic acid salts or its derivatives thereof.

In another aspect of the present invention, there is provided a method of controlling phytopathogenic fungal diseases by applying to the plants or to their locus or to plant propagation material, an agrochemical composition comprising: (a) at least one pyrazolecarboxamide fungicide or a derivative thereof; (b) at least one or more additional fungicide selected from the group comprising dithiocarbamate and conazole fungicides; and (c) at least two surfactants comprising aryl sulphonic acid salts or its derivatives thereof.

In another aspect of the present invention, the agrochemical composition is used as a fungicide.

### OBJECTIVES OF THE PRESENT INVENTION

An objective of the present invention is to provide an agrochemical composition comprising a pyrazolecarboxamide fungicide or a derivative thereof.

Another objective of the present invention is to provide water dispersible granules comprising a pyrazolecarboxamide fungicide or a derivative thereof.

Another objective of the present invention is to provide water dispersible granules comprising a pyrazolecarboxamide fungicide or a derivative thereof in combination with other active ingredients.

Another objective of the present invention is to provide water dispersible granules comprising a pyrazolecarboxamide fungicide or a derivative thereof with improved suspensibility and greater dispersibility.

Still another objective of the present invention is to provide a method of controlling pests using an agrochemical composition comprising a pyrazolecarboxamide fungicide or a derivative thereof.

### DETAILED DESCRIPTION OF THE INVENTION

The following description is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms used in the following description and claims are not limited to the bibliographical meanings but are merely used by the inventor to enable a clear and consistent understanding of the invention. Accordingly, it should be apparent to those skilled in the art that the following description of exemplary embodiments of the present disclosure are provided for illustration purpose only and not for limiting the scope of the invention as defined by the appended claims and their equivalents.

For the purposes of the present disclosure, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present disclosure in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term.

Prior to setting forth the present subject matter in detail, it may be helpful to provide definitions of certain terms used herein. Unless defined otherwise, all technical and scientific terms used herein have the same meaning as is commonly understood by one of skill in the art to which this subject matter pertains. The following definitions are provided for clarity.

Unless defined otherwise, all technical and scientific terms used herein have the same meaning as commonly understood by one of ordinary skill in the art to which this invention belongs. It must be noted that, as used in this specification, the singular forms “a”, “an” and “the” include plural referents unless the content clearly dictates otherwise.

As used herein, the terms “comprising”, “including”, “having”, “containing”, “involving”, and the like are to be understood to be open-ended, i.e., to mean including but not limited to. The terms “preferred” and “preferably” refer to embodiments of the invention that may afford certain benefits, under certain circumstances.

The aspects and embodiments described herein shall also be interpreted to replace the clause “comprising” with either “consisting of” or with “consisting essentially of” or with “consisting substantially of”.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.2%, 0.3%, etc. up to 80%.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

As used herein, the term “agrochemical” is understood to denote an agricultural chemical such as pesticides, fungicides, insecticides, acaricides, herbicides, nematicides, plant growth regulators and can be used interchangeably.

As used herein, the term “fungicide” refers to the ability of a substance to decrease or inhibit growth of fungi or oomycetes.

As used herein the term “plant” or “crop” refers to whole plants, plant organs (e.g., leaves, stems, twigs, roots, trunks, limbs, shoots, fruits etc.), plant cells, or plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

The term “locus” as used herein denotes the vicinity or area designated for growth of a desired crop, and in which control of the growth and/or spread of undesirable vegetation is desired. The locus includes the vicinity of desired crop plants wherein undesirable vegetation growth has either occurred, is most likely to occur, or is yet to occur.

The term “plant propagation material” refers to the parts of the plant, such as seeds, which can be used for the propagation of the plant and vegetative plant material. There may be mentioned, e.g., the seeds (in the strict sense), roots, fruits, tubers, bulbs, rhizomes, parts of plants. Germinated plants or young plants, which may be transplanted after germination or after emergence from the soil.

The term “seed” embraces seeds and plant propagules of all kinds including but not limited to true seeds, seed pieces, suckers, corms, bulbs, fruit, tubers, grains, cuttings, cut shoots and the like and means in a preferred embodiment true seed.

The salts referred to herein are agriculturally acceptable salts. As used herein, an “agriculturally acceptable salt” means a salt which is known and accepted for use in agricultural or horticultural use.

The term “stable” referred to herein refers to chemical and/or physical stabilization of the composition in terms of achieving chemical stability of the active ingredient and desired suspensibility and dispersibility of the composition by maintaining homogeneity of the components that impart shelf life up to 2 years.

The term “control” or “controlling” fungus means to inhibit, and/or supress the ability of fungus to grow and/or reproduce, or to limit fungus-related damage or loss in crop plants or denotes control and prevention of a disease. Controlling effects include all deviation from natural development, for example: killing, retardation, decrease of the fugal disease.

The term “binary surfactant mixture” means a surfactant mixture comprising two surfactants selected from aryl sulphonic acid salts or its derivatives thereof. The terms “binary surfactant mixture” and “at least two surfactants” can be used interchangeably.

The inventors of the present invention surprisingly found that a combination of at least two aryl sulphonic acid salts provides a stabilizing effect to the pyrazolecarboxamide compound, such as fluindapyr in a water dispersible granular system, either alone or when combined with other active ingredients. The combination of specific surfactants obtained by combining at least two aryl sulphonic acid salt in the granular system aided in efficient granular formation by providing desired binding effect and at the same time, it facilitated dispersion of actives when diluted with the water. The binary mixture comprising a salt of aryl sulphonic acid derivative provides efficient wetting and another aryl sulphonic acid condensate salt provides efficient dispersion required in formulating water dispersible granules. Such a binary mixture of diverse physico-chemical characteristics overall lowers the dynamic surface tension. Therefore, inventors found that the binary surfactant mixture comprising at least two aryl sulphonic acid salts greatly facilitated granular formulation of pyrazolecarboxamide compound either alone or in combination with other active ingredients. Also, the binary surfactant mixture was found to be very effective in providing quick dispersion of the active ingredients combined in the granules.

According to an embodiment of the present invention, an agrochemical composition comprises:
(a) at least one pyrazolecarboxamide fungicide or a derivative thereof; and
(b) at least two surfactants.

In another embodiment of the present invention, an agrochemical composition comprises:
(a) at least one pyrazolecarboxamide fungicide or a derivative thereof; and
(b) at least two surfactants comprising aryl sulphonic acid salts or its derivatives thereof.

According to an embodiment of the present invention, the pyrazolecarboxamide fungicide is selected from the group comprising benzovindiflupyr, bixafen, flubeneteram, fluindapyr, fluxapyroxad, furametpyr, inpyrfluxam, isopyrazam, penflufen, penthiopyrad, pydiflumetofen, pyrapropoyne, sedaxane, or a derivative thereof.

According to an embodiment of the present invention the pyrazolecarboxamide fungicide is selected from the group comprising benzovindiflupyr, bixafen, fluindapyr, fluxapyroxad, or a derivative thereof.

According to an embodiment of the present invention the pyrazolecarboxamide fungicide is fluindapyr or a derivative thereof.

According to an embodiment of the present invention the pyrazolecarboxamide fungicide is bixafen or a derivative thereof.

According to an embodiment of the present invention, the agrochemical composition comprises from about 0.1% w/w to about 80% w/w pyrazolecarboxamide fungicide of the total weight of the composition.

In another embodiment, the composition comprises from about 1% w/w to about 70% w/w pyrazolecarboxamide fungicide of total weight of the composition.

In another embodiment, the composition comprises from about 1% w/w to about 55% w/w pyrazolecarboxamide fungicide of total weight of the composition.

In a preferred embodiment, the agrochemical composition comprises about 51.55% w/w fluindapyr of total weight of the composition.

In a preferred embodiment, the composition comprises from about 1% w/w to about 30% w/w fluindapyr or a derivative thereof of total weight of the composition.

In a preferred embodiment, the agrochemical composition comprises about 3.73% w/w fluindapyr of total weight of the composition.

According to an embodiment, the concentration of fluindapyr ranges from about 1 g/L to about 50 g/L.

In an embodiment, the concentration of fluindapyr ranges from about 10 g/L to about 40 g/L.

In a preferred embodiment, the concentration of fluindapyr is about 35 g/L.

According to an embodiment of the present invention, an agrochemical composition comprises combination of surfactants comprising aryl sulphonic acid salts or its derivatives.

According to an embodiment of the present invention, an agrochemical composition comprises:
a) at least one pyrazolecarboxamide fungicide or a derivative thereof; and
b) at least two surfactants comprising aryl sulphonic acid salts or its derivatives.

According to an embodiment of the present invention, the aryl sulphonic acid salts or its derivatives are selected from the group comprising alkyl aryl sulfonates, aryl sulfonate-formaldehyde condensate, alkyl aryl sulfonate-formaldehyde condensate, or combinations thereof.

According to an embodiment of the present invention, the aryl sulphonic acid salts or its derivatives are selected from the group comprising alkyl aryl sulfonates, having C₁₋₁₀ alkyl groups, aryl sulfonate-formaldehyde condensate or alkyl aryl sulfonate-formaldehyde condensate having C₁₋₁₀ alkyl groups, or alkyl naphthalene sulfonates, preferably having C₁₋₁₀ alkyl groups, such as methyl, isopropyl, n-butyl, sec-butyl, and nonyl for example, sodium butyl naphthalene sulfonate and sodium nonyl naphthalene sulfonate; naphthalene sulfonate-formaldehyde condensate or alkyl naphthalene sulfonate-formaldehyde condensate. The naphthalene sulfonate-formaldehyde condensate or alkyl naphthalene sulfonate-formaldehyde condensate to be used in the compositions is preferably a sodium salt having a mean molecular weight of 300 to 2,000, preferably 400 to 1,000 and most preferably 500-750. When present, the alkyl groups comprise C₁₋₃ alkyl groups. Similarly, condensate of aromatic sulfonic acids such as sodium isopropyl naphthalene sulfonate, sodium dodecylbenzenesulfonate and sodium polycarboxylate mixture, sodium lauryl sulfate, calcium dioctyl naphthalene sulfonate, linear dodecylbenzene sulfonic acid, branched dodecylbenzene sulfonic acid and linear dodecylbenzene sulfonate isopropylamine salt.

According to an embodiment of the present invention, the aryl sulphonic acid salts or its derivatives are selected from the group comprising alkyl aryl sulfonates having C₁₋₁₀ alkyl groups, aryl sulfonate-formaldehyde condensate or alkyl aryl sulfonate-formaldehyde condensate having C₁₋₁₀ alkyl groups.

According to an embodiment of the present invention, the agrochemical composition comprises a binary surfactant mixture, wherein the binary surfactant mixture comprises two surfactants selected from aryl sulphonic acid salts or its derivatives thereof.

According to an embodiment of the present invention, the binary surfactant mixture comprises sodium salt of naphthalenesulphonic acid formaldehyde condensate, and sodium diisopropylenenaphthalene sulphonate.

According to an embodiment of the present invention, the composition comprises from about 0.1% w/w to about 30% w/w aryl sulphonic acid salts or its derivatives of total weight of the composition.

In an embodiment of the present invention, the agrochemical composition comprises from about 0.5% w/w to about 30% w/w aryl sulphonic acid salts or its derivatives of total weight of the composition.

In an embodiment of the present invention, the agrochemical composition comprises from about 1% w/w to about 30% w/w aryl sulphonic acid salts or its derivatives of total weight of the composition.

According to an embodiment of the present invention, the agrochemical composition comprises from about 0.1% w/w to about 30% w/w binary surfactant mixture of total weight of the composition.

In an embodiment of the present invention, the agrochemical composition comprises from about 0.5% w/w to about 30% w/w binary surfactant mixture of total weight of the composition.

In an embodiment of the present invention, the agrochemical composition comprises from about 1% w/w to about 30% w/w binary surfactant mixture of total weight of the composition.

In a preferred embodiment, the composition comprises about 4% w/w sodium diisopropylenenaphthalene sulphonate of total weight of the composition.

In a preferred embodiment, the composition comprises about 2% w/w sodium diisopropylenenaphthalene sulphonate of total weight of the composition.

In a preferred embodiment, the composition comprises about 4% w/w sodium salt of naphthalenesulphonic acid formaldehyde condensate of total weight of the composition.

According to an embodiment, the two surfactants are present in a weight ratio ranging from about 1:1 to about 1:10.

In an embodiment, the two surfactants selected from aryl sulphonic acid salt, or its derivatives thereof are present in a weight ratio ranging from about 1:1 to about 1:10.

In an embodiment, the binary surfactant mixture comprising aryl sulphonic acid salt, or its derivatives thereof are present in a weight ratio ranging from about 1:1 to about 1:10.

In another embodiment, the sodium diisopropylenenaphthalene sulphonate and the sodium salt of naphthalenesulphonic acid formaldehyde condensate are present in a weight ratio ranging from about 1:1 to about 1:10.

In another embodiment, the sodium diisopropylenenaphthalene sulphonate and the sodium salt of naphthalenesulphonic acid formaldehyde condensate are present in a weight ratio ranging from about 1:1 to about 1:5.

In a preferred embodiment, the sodium diisopropylenenaphthalene sulphonate and the sodium salt of naphthalenesulphonic acid formaldehyde condensate are present in a weight ratio ranging of about 1:1.

In a preferred embodiment, the sodium diisopropylenenaphthalene sulphonate and the sodium salt of naphthalenesulphonic acid formaldehyde condensate are present in a weight ratio ranging of about 1:2.

In an embodiment of the present invention, the agrochemical composition comprises: (a) fluindapyr; and (b) at least two surfactants comprising aryl sulphonic acid salts or its derivatives.

In an embodiment of the present invention, the agrochemical composition comprises: (a) fluindapyr; and (b) at least two surfactants comprising sodium salt of naphthalenesulphonic acid formaldehyde condensate, and sodium diisopropylenenaphthalene sulphonate.

In an embodiment of the present invention, the agrochemical composition comprises: (a) bixafen; and (b) at least two surfactants comprising aryl sulphonic acid salts or its derivatives.

In an embodiment of the present invention, the agrochemical composition comprises: (a) bixafen; and (b) at least two surfactants comprising sodium salt of naphthalenesulphonic acid formaldehyde condensate, and sodium diisopropylenenaphthalene sulphonate.

According to an embodiment of the present invention, an agrochemical composition comprises:
a) at least one pyrazolecarboxamide fungicide or a derivative thereof;
b) at least one or more active ingredients or derivatives thereof; and
c) at least two surfactants comprising aryl sulphonic acid salts or its derivatives thereof.

According to an embodiment of the present invention, an agrochemical composition comprises at least one or more active ingredients or derivatives thereof.

In another embodiment, the one or more active ingredients comprise at least one or more additional fungicide or a derivative thereof.

In an embodiment, the agrochemical composition further comprises at least one or more additional fungicide or a derivative thereof.

According to an embodiment of the present invention, an agrochemical composition comprises:
a) at least one pyrazolecarboxamide fungicide or a derivative thereof;
b) at least one or more additional fungicide or a derivative thereof; and
c) at least two surfactants comprising aryl sulphonic acid or its derivatives thereof.

According to an embodiment of the present invention, an agrochemical composition comprises:
a) at least one pyrazolecarboxamide fungicide or a derivative thereof;
b) at least one or more additional fungicide selected from the group comprising dithiocarbamate, conazole, benzimidazole, strobilurin and copper group of fungicides or derivatives thereof; and
c) at least two surfactants comprising aryl sulphonic acid or its derivatives thereof.

According to an embodiment of the present invention, an agrochemical composition comprises:
a) at least one pyrazolecarboxamide fungicide or a derivative thereof;
b) at least one or more additional fungicide selected from the group comprising dithiocarbamate and conazole fungicides or derivatives thereof; and
c) at least two surfactants comprising aryl sulphonic acid or its derivatives thereof.

According to an embodiment, the additional fungicide is selected from the group comprising dithiocarbamate, conazole, benzimidazole, strobilurins, and a copper group of fungicides or derivatives thereof.

According to an embodiment of the present invention, the agrochemical composition comprises a dithiocarbamate fungicide.

According to an embodiment of the present invention, the agrochemical composition comprises a dithiocarbamate fungicide selected from the group comprising azithiram, manam, thiram, ziram, dazomet, mancopper, mancozeb, maneb, metiram, propineb and zineb.

According to an embodiment of the present invention, the dithiocarbamate fungicide is mancozeb.

According to an embodiment of the present invention, the agrochemical composition comprises a conazole fungicide.

According to an embodiment of the present invention, the agrochemical composition comprises a conazole fungicide selected from the group comprising azaconazole, bromuconazole, cyproconazole, diclobutrazol, difenoconazole, epoxiconazole, etaconazole, fenbuconazole, flusilazole, flutriafol, furconazole, hexaconazole, metconazole, myclobutanil, penconazole, propiconazole, prothioconazole, quinconazole, simeconazole, tebuconazole, tetraconazole, triticonazole and uniconazole.

According to an embodiment of the present invention, the conazole fungicide is prothioconazole.

According to an embodiment of the present invention, the conazole fungicide is tebuconazole.

According to an embodiment of the present invention, the conazole fungicide is difenoconazole.

According to an embodiment of the present invention, the conazole fungicide is hexaconazole.

In a preferred embodiment, the benzimidazole fungicide is selected from the group comprising albendazole, benomyl, carbendazim, chlorfenazole, cypendazole, dimefluazole, fuberidazole, and thiabendazole; and wherein the strobilurins are selected from the group comprising azoxystrobin, fluoxastrobin, picoxystrobin, pyraoxystrobin, pyraclostrobin, pyrametostrobin, fenaminstrobin, metominostrobin, kresoxim-methyl, and trifloxystrobin; and wherein the copper group of fungicides are selected from the group comprising basic copper carbonate, basic copper sulfate, tribasic copper sulphate, copper glycinate, Bordeaux mixture, copper hydroxide, copper oxychloride, copper sulfate, cuprous oxide, and mancopper.

According to an embodiment of the present invention, the agrochemical composition comprises a benzimidazole fungicide.

According to an embodiment of the present invention, the agrochemical composition comprises a benzimidazole fungicide selected from the group comprising albendazole, benomyl, carbendazim, chlorfenazole, cypendazole, dimefluazole, fuberidazole, thiabendazole.

According to an embodiment of the present invention, the agrochemical composition comprises a strobilurin fungicide.

According to an embodiment of the present invention, the agrochemical composition comprises a strobilurin fungicide selected from the group comprising azoxystrobin, fluoxastrobin, picoxystrobin, pyraoxystrobin, pyraclostrobin, pyrametostrobin, fenaminstrobin, metominostrobin, kresoxim-methyl and trifloxystrobin.

According to an embodiment of the present invention, the agrochemical composition comprises a copper fungicide.

According to an embodiment of the present invention, the agrochemical composition comprises a copper fungicide selected from the group comprising basic copper carbonate, basic copper sulfate, tribasic copper sulphate, copper glycinate, Bordeaux mixture, copper hydroxide, copper oxychloride, copper sulfate, cuprous oxide and mancopper.

According to an embodiment of the present invention, the agrochemical composition comprises from about 0.1% w/w to about 90% w/w fungicide of total weight of the composition.

In another embodiment, the composition comprises from about 0.5% w/w to about 90% w/w fungicide of total weight of the composition.

In a preferred embodiment of the present invention, the agrochemical composition comprises from about 1% w/w to about 90% w/w fungicide of total weight of the composition.

In a preferred embodiment, the agrochemical composition comprises about 62% w/w mancozeb of total weight of the composition.

In a preferred embodiment, the agrochemical composition comprises about 61.62% w/w mancozeb of total weight of the composition.

According to an embodiment, the concentration of mancozeb ranges from about 100 g/L to about 700 g/L.

In an embodiment, the concentration of mancozeb ranges from about 200 g/L to about 600 g/L.

In a preferred embodiment, the concentration of mancozeb is about 525 g/L.

According to an embodiment, the concentration of prothioconazole ranges from about 1 g/L to about 100 g/L.

In an embodiment, the concentration of prothioconazole ranges from about 10 g/L to about 60 g/L.

In a preferred embodiment, the concentration of prothioconazole is about 44 g/L.

According to an embodiment, the agrochemical composition further comprises at least one agrochemically acceptable excipient.

According to an embodiment, the agrochemical composition comprises a) at least one fungicide selected from fluindapyr or bixafen; b) mancozeb; c) prothioconazole; d) at least two aryl sulphonic acid salts or its derivatives thereof; and e) optionally at least one agrochemically acceptable excipient thereof.

According to an embodiment of the present invention, the agrochemical composition comprises: (a) fluindapyr; (b) mancozeb; (c) prothioconazole; (d) at least two surfactants comprising at least two aryl sulphonic acid salts or its derivatives; and e) optionally at least one agrochemically acceptable excipient thereof.

According to an embodiment of the present invention, the agrochemical composition comprises: (a) fluindapyr; (b) mancozeb; (c) prothioconazole; (d) at least two surfactants comprising sodium salt of naphthalenesulphonic acid formaldehyde condensate and sodium diisopropylenenaphthalene sulphonate; and e) optionally at least one agrochemically acceptable excipient thereof.

According to an embodiment of the present invention, the agrochemical composition comprises: (a) bixafen; (b) mancozeb; (c) prothioconazole; (d) at least two surfactants comprising at least two aryl sulphonic acid salts or its derivatives; and e) optionally at least one agrochemically acceptable excipient thereof.

According to an embodiment of the present invention, the agrochemical composition comprises: (a) bixafen; (b) mancozeb; (c) prothioconazole; (d) at least two surfactants comprising sodium salt of naphthalenesulphonic acid formaldehyde condensate and sodium diisopropylenenaphthalene sulphonate; and e) optionally at least one agrochemically acceptable excipient thereof.

According to an embodiment of the present invention, an agrochemical composition comprises:
a) at least one pyrazolecarboxamide fungicide or a derivative thereof;
b) at least one fungicide selected from the group comprising dithiocarbamate and conazole fungicides or derivatives thereof;
c) at least two surfactants comprising aryl sulphonic acid or its derivatives, and
d) optionally at least one agrochemically acceptable excipient.

In an embodiment, the agrochemically acceptable excipient can be selected from any or a combination of a surfactant, a preservative, a coloring agent, a pH adjusting agent, antifoaming agent and a solvent. However, it should be appreciated that any other agrochemically acceptable excipients, as known to a person skilled in the art, may be used to serve its intended purpose.

According to an embodiment of the present disclosure, the surfactants comprise anionic surfactants and non-ionic surfactants. The anionic surfactants are selected the group comprising alkyl and aryl sulfates, including sodium alkyl sulfates, polyoxyalkylene alkylether sulfate, polyoxyalkylene alkylaryl ether sulfates, polyoxyalkylene styrylphenyl ether sulfate, alkylphosphates, polyoxyalkylene alkyl phosphates, polyoxyalkylene phenylether phosphate, polyoxyalkylphenol phosphates, poly-carboxylates, fatty acids and salts thereof, alkyl glycinates, acyl glutamates, acyl sarcosinates, alkyl sulfoacetates, acylated peptides, alkyl ether carboxylates, acyl lactylates and mixtures thereof. The non-ionic surfactants are selected from the group comprising ethoxylated fatty acids, alcohol ethoxylates, tristyrylphenol ethoxylates, ethoxylated sorbitan fatty acid esters (examples include polyoxyethylene sorbitan esters widely known as polysorbates), and combinations thereof.

In another embodiment, suitable preservatives are for example benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl, benzoic acid, or combinations thereof.

In an embodiment, the coloring agents may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

According to an embodiment, antifoaming agent may be selected from polydimethoxysiloxane, polydimethylsiloxane, emulsion of polysiloxane, alkyl poly acrylates, castor oil, fatty acids, fatty acids esters, fatty acids sulfate, fatty alcohol, fatty alcohol esters, fatty alcohol sulfate, foot olive oil, mono & di glyceride, paraffin oil, paraffin wax, poly propylene glycol, silicone, silicone oil, vegetable fats, vegetable fats sulfate, vegetable oil, vegetable oil sulfate, vegetable wax, vegetable wax sulfate, agents based on silicon or magnesium stearate, and blend of maltodextrin, and methylated silica.

According to an embodiment, examples of suitable solvents are water, oils of vegetable, or derivatives. In principle, solvent mixtures may also be used.

In an embodiment, the agrochemically acceptable excipients are present in an amount ranging from about 5% w/w to about 99% w/w of total weight of the composition.

In a preferred embodiment, the agrochemically acceptable excipients are present in an amount ranging from about 5% w/w to about 30% w/w of total weight of the composition.

In an embodiment, the agrochemical provided in the solid form comprises inactive ingredients or binders. A wide variety of binders can be used, like for example lactose powder, dibasic calcium phosphate, sucrose, corn (maize) starch, microcrystalline cellulose or modified cellulose, like for example hydroxymethyl cellulose.

In an embodiment, the agrochemical composition may also contain an ingredient that can act as a disintegrant, which hydrates readily in water and thereby improves the dispersion of the composition in water. Some of the above-mentioned binders, like for example starch and cellulose, can also be used as a disintegrant.

In an embodiment, the commonly used lubricants are for example magnesium stearate, stearic acid (stearine), hydrogenated oil and sodium stearyl fumarate.

In an embodiment, the binding agent may include any or a combination of polyvinyl alcohols, phenyl naphthalene sulphonate, lignin derivatives, polyvinyl pyrrolidone, polyalkylpyrrolidone, carboxymethylcellulose, xanthan gum, polyethoxylated fatty acids, polyethoxylated fatty alcohols, ethylene oxide copolymer, propylene oxide copolymer, polyethylene glycols and polyethylene oxides, but not limited thereto.

In an embodiment, the anti-freezing agents may include any or a combination of ethylene glycol, propylene glycol, urea, glycerin and anti-freeze proteins, but not limited thereto.

In an embodiment, the minerals may include any or a combination of kaolin, silica, titanium (IV) oxide, rutile, anatase, aluminum oxides, aluminum hydroxides, iron oxide, iron sulfide, magnetite, pyrite, hematite, ferrite, gregite, calcium carbonate, calcite, aragonite, quartz, zircon, olivine, orthopyroxene, tourmaline, kyanite, albite, anorthite, clinopyroxene, orthoclase, gypsum, andalusite, talc, fluorite, apatite, orthoclase, topaz, corundum, diamond, tin, tin oxides, antimony, antimony oxides, beryllium, cobalt, copper, feldspar, gallium, indium, lead, lithium, manganese, mica, molybdenum, nickel, perlite, platinum group metals, phosphorus and phosphate rock, potash, rare earth elements, tantalum, tungsten, vanadium, zeolites, zinc and zinc oxide, and indium tin oxide, but not limited thereto.

In an embodiment, the fillers may include any or a combination of diatomaceous earth, kaolin, bentonite, precipitated silica, attapulgite, and perlite, but not limited thereto.

In an embodiment, the composition further comprises at least one from the group of fertilizers, mycorrhiza, micronutrients, acaricides, algicides, antifeedants, avicides, bactericides, bird repellents, chemosterilants, fungicides, herbicide safeners, herbicides, insect attractants, insect repellents, insecticides, mammal repellents, mating disruptors, molluscicides, nematicides, plant activators, plant-growth regulators, rodenticides, synergists, virucides, derivatives thereof, biological control agents and mixtures thereof.

In an embodiment, the agrochemical compositions of the present disclosure can be formulated in any of formulations, wettable powder, soluble powder, water dispersible granule, granules, dusts, microgranule seed treatment formulation and the likes as known to persons skilled in the art.

In another embodiment, the agrochemical composition is present in a form of a solid composition.

In another embodiment, the solid agrochemical composition is present in a form of water dispersible granules (WDG).

According to an embodiment, the solid agrochemical composition comprises:
a) at least one fungicide selected from fluindapyr or bixafen;
b) mancozeb;
c) prothioconazole;
d) at least two aryl sulphonic acid salts or its derivatives thereof.

In another embodiment, the solid agrochemical composition comprises:
a) fluindapyr;
b) mancozeb;
c) prothioconazole;
d) at least two aryl sulphonic acid salts or its derivatives thereof; and
e) optionally at least one agrochemically acceptable excipient thereof.

In another embodiment, the solid agrochemical composition comprises:
a) bixafen;
b) mancozeb;
c) prothioconazole;
d) at least two aryl sulphonic acid salts or its derivatives thereof; and
e) optionally at least one agrochemically acceptable excipient thereof.

According to an embodiment, water dispersible granular (WDG) composition comprises:
a) at least one fungicide selected from fluindapyr or bixafen;
b) mancozeb;
c) prothioconazole;
d) at least two aryl sulphonic acid salts or its derivatives thereof.

In another embodiment, water dispersible granular (WDG) composition comprises:
a) fluindapyr;
b) mancozeb;
c) prothioconazole;
d) at least two aryl sulphonic acid salts or its derivatives thereof; and
e) optionally at least one agrochemically acceptable excipient thereof.

In another embodiment, water dispersible granular (WDG) composition comprises:
a) bixafen;
b) mancozeb;
c) prothioconazole;
d) at least two aryl sulphonic acid salts or its derivatives thereof; and
e) optionally at least one agrochemically acceptable excipient thereof.

According to an embodiment of the present invention, a process of preparing an agrochemical composition comprises:
(i) mixing a pyrazolecarboxamide fungicide or a derivative thereof, at least two surfactants and optionally at least one agrochemically acceptable excipient to obtain a homogeneous mixture; and
(ii) granulating the homogeneous mixture of step (i) by suitable means.

According to an embodiment of the present invention, a process of preparing an agrochemical composition comprises:
(i) mixing a pyrazolecarboxamide fungicide or a derivative thereof, at least two surfactants comprising aryl sulphonic acid salts or its derivatives thereof and optionally at least one agrochemically acceptable excipient to obtain a homogeneous mixture; and
(ii) granulating the homogeneous mixture of step (i) by suitable means.

According to an embodiment of the present invention, a process of preparing the agrochemical composition comprises:
(i) mixing a pyrazolecarboxamide fungicide or a derivative thereof, one or more additional fungicides or a derivative thereof, at least two surfactants comprising aryl sulphonic acid salts or its derivatives thereof and optionally at least one agrochemically acceptable excipient to obtain a homogeneous mixture;
(ii) granulating the homogeneous mixture of step (i) by suitable means.

According to an embodiment of the present invention, a process of preparing the agrochemical composition comprises:
(i) mixing a pyrazolecarboxamide fungicide or a derivative thereof, at least two surfactants comprising aryl sulphonic acid salts or its derivatives thereof and optionally at least one agrochemically acceptable excipient to obtain a homogeneous mixture;
(ii) granulating the homogeneous mixture of step (i) by suitable means; (iii) drying the granules to obtain an agrochemical composition.

In an embodiment, the step (ii) comprises granulating the homogenous mixture of step (i) by suitable means, wherein the suitable means comprise pan granulation, spray drying, extrusion, and combinations thereof.

According to an embodiment of the present invention, a process of preparing an agrochemical composition comprises:
(i) mixing, blending and milling a pyrazolecarboxamide fungicide or a derivative thereof, one or more additional fungicides or a derivative thereof, at least two surfactants and optionally at least one agrochemically acceptable excipient to obtain a homogeneous mixture;
(ii) obtaining granules from the homogeneous mixture of (i); and
(iii) drying the granules to obtain an agrochemical composition.

According to an embodiment of the present invention, the process of preparing an agrochemical composition comprises:
(i) mixing, blending and milling fluindapyr or a derivative thereof and one or more additional fungicide or a derivative thereof to achieve a particle size of less than about 10 microns (μ);
(ii) mixing at least two surfactants comprising naphthalenesulphonic acid formaldehyde condensate sodium salt, and sodium diisopropylenenaphthalene sulphonate with water;
(iii) adding (i) and (ii) to obtain a slurry;
(iv) subjecting the slurry to spray drying to obtain granules; and
(v) drying the granules to obtain the agrochemical composition.

According to an embodiment of the present invention, the process of preparing an agrochemical composition comprises:
(i) mixing, blending and milling fluindapyr or a derivative thereof and prothioconazole or a derivative thereof, and optionally at least one agrochemically acceptable excipient to obtain a homogeneous mixture;
(ii) mixing at least two surfactants comprising naphthalenesulphonic acid formaldehyde condensate sodium salt, and sodium diisopropylenenaphthalene sulphonate with water;
(iii) adding (i) and (ii) to obtain a slurry;
(iv) adding mancozeb to the slurry of step (iii) and mixing to obtain homogeneous mixture;
(v) subjecting homogeneous mixture of step (iv) to spray drying to obtain granules; and
(vi) drying the granules to obtain the agrochemical composition.

According to an embodiment of the present invention, there is provided a process of preparing agrochemical composition comprising: (a) at least one pyrazolecarboxamide fungicide or a derivative thereof, and (b) at least two surfactants comprising aryl sulphonic acid or its derivatives; in the form of WDG, wherein said WDG may be prepared by pan granulation, spray drying or extrusion.

According to an embodiment of the present invention, there is provided a process of preparing agrochemical composition comprising: (a) at least one pyrazolecarboxamide fungicide or a derivative thereof, and (b) at least two surfactants comprising aryl sulphonic acid or its derivatives; in the form of WDG, wherein said WDGs are processed by way of spray drying.

In an embodiment, the order of addition and mixing of the agrochemical ingredients and/or excipients is not narrowly critical.

According to an embodiment of the present invention, when more than one fungicide is combined to obtain water dispersible granules, the fungicides may be subjected to milling operation to reduce the particle size.

According to an embodiment of the present invention, when more than one fungicide is combined to obtain water dispersible granules, the fungicides may be subjected to milling to obtain uniform particle size ranging from about 5 μm to about 50 μm.

According to an embodiment of the present invention, when more than one fungicide is combined to obtain water dispersible granules, the fungicides may be subjected to milling to obtain a uniform particle size ranging from about 8 μm to about 10 μm.

According to an embodiment of the present invention, the blend is obtained using a suitable blender such as ribbon blender, V-blender, high intensity low mixer, plough shear mixer, and kneader mixer.

According to an embodiment of the present invention, a blend of fluindapyr fungicide or a derivative thereof, at least one more fungicide, at least two surfactants and agrochemical excipients may be taken for milling.

In an embodiment, the grinding may be performed in a suitable device such as air jet mill, air classifier mill, hammer mill, and pin disc mill. Jet mills are shear or pulverizing machines in which the particles to be milled are accelerated by gas flows and pulverized by collision. There are a number of different types of jet mill designs, such as double counterflow (opposing jet) and spiral (pancake) fluid energy mills.

According to an embodiment of the present invention, water dispersible granules are normally made through spray drying process.

According to an embodiment of the present invention, the inlet temperature during spray drying is maintained from about 90° C. to about 120° C.

According to an embodiment of the present invention, the outlet temperature during spray drying is maintained at about 55° C.

According to an embodiment of the present invention, drying of granules may be performed in a suitable drying equipment such as spray drier or fluidized bed spray drier or fluid bed spray granulator.

According to an embodiment of the present invention, the drying of granules is done in fluidized bed dryer at a temperature of about 60° C. for about 60 minutes to get moisture content of final product of about less than 2%.

In an embodiment, the drying process will preferably remove as much water as possible in order to reduce weight and to provide good stability to the granules while still in a dry flowable state. Preferably the granules will have less than about 2% weight loss on drying and most preferably less than about 1% weight loss on complete drying.

According to an embodiment of the present invention, ingredients used in the process of preparing the composition may be in a finely divided form, preferably in an air-milled form.

In an embodiment of the present invention, the pH of the agrochemical composition is adjusted between 4 to 7.

According to an embodiment of the present invention, there is provided a method of controlling phytopathogenic diseases by applying to the plants or to their locus, an agrochemical composition comprising: (a) at least one pyrazolecarboxamide fungicide or a derivative thereof; and (b) at least two surfactants.

In another embodiment, there is provided a method of controlling phytopathogenic fungal diseases by applying to a plant or locus or plant propagation material thereof, an agrochemical composition comprising: (a) at least one pyrazolecarboxamide fungicide or a derivative thereof; (b) at least two surfactants comprising aryl sulphonic acid salts or its derivatives thereof; and (c) optionally at least one agrochemically acceptable excipient thereof.

In another embodiment, the agrochemical composition further comprises at least one or more additional fungicides selected from the group comprising dithiocarbamate fungicide and conazole fungicide.

According to an embodiment of the present invention, there is provided a method of controlling phytopathogenic diseases by applying to the plants or to their locus, an agrochemical composition comprising: (a) fluindapyr; and (b) at least two surfactants.

According to an embodiment of the present invention, there is provided a method of controlling phytopathogenic diseases by applying to the plants or to their locus, an agrochemical composition comprising: (a) fluindapyr; and (b) at least two surfactants comprising aryl sulphonic acid salts or its derivatives.

According to an embodiment of the present invention, there is provided a method of controlling phytopathogenic diseases by applying to the plants or to their locus, an agrochemical composition comprising: (a) bixafen; and (b) at least two surfactants comprising aryl sulphonic acid salts or its derivatives.

According to an embodiment of the present invention, there is provided a method of controlling phytopathogenic diseases by applying to the plants or to their locus, an agrochemical composition comprising: (a) fluindapyr; and (b) at least two surfactants comprising sodium salt of naphthalenesulphonic acid formaldehyde condensate, and sodium diisopropylenenaphthalene sulphonate.

According to an embodiment of the present invention, there is provided a method of controlling phytopathogenic diseases by applying to the plants or to their locus, an agrochemical composition comprising: (a) bixafen; and (b) at least two surfactants comprising sodium salt of naphthalenesulphonic acid formaldehyde condensate, and sodium diisopropylenenaphthalene sulphonate.

According to an embodiment of the present invention, there is provided a method of controlling phytopathogenic diseases by applying to the plants or to their locus, an agrochemical composition comprising: (a) fluindapyr, (b) mancozeb, (c) prothioconazole and (d) at least two surfactants comprising at least two aryl sulphonic acid salts or its derivatives.

According to an embodiment of the present invention, there is provided a method of controlling phytopathogenic diseases by applying to the plants or to their locus, an agrochemical composition comprising: (a) fluindapyr, (b) mancozeb, (c) prothioconazole and (d) at least two surfactants comprising sodium salt of naphthalenesulphonic acid formaldehyde condensate, and sodium diisopropylenenaphthalene sulphonate.

According to an embodiment of the present invention, there is provided a method of controlling phytopathogenic diseases by applying to the plants or to their locus, an agrochemical composition comprising: (a) fluindapyr, (b) mancozeb, (c) prothioconazole, (d) at least two surfactants comprising sodium salt of naphthalenesulphonic acid formaldehyde condensate, and sodium diisopropylenenaphthalene sulphonate and (e) optionally at least one agrochemically acceptable excipient.

According to an embodiment of the present invention, there is provided a method of controlling phytopathogenic diseases by applying to the plants or to their locus, an agrochemical composition comprising: (a) bixafen, (b) mancozeb, (c) prothioconazole, (d) at least two surfactants comprising sodium salt of naphthalenesulphonic acid formaldehyde condensate, and sodium diisopropylenenaphthalene sulphonate and (e) optionally at least one agrochemically acceptable excipient.

According to an embodiment of the present invention, the agrochemical composition is used to defend several varieties of fruits, vegetables, nuts and field crops against a wide spectrum of fungal infestations, including potato blight, tomato blight, leaf spot, scab (on apples and pears), and rust (on roses). It may also be used for removal of fungicidal infection of cotton, potatoes, corn, safflower, sorghum, peanuts, tomatoes, flax, chilly, groundnut, cluster bean (Guar), pulses, cucurbits, cereals, ornamental plants including rose and marigold, fruits including apple and spices including cumin.

According to an embodiment of the present invention, the agrochemical composition exhibits a broad range of fungicide activity against a large number of target pathogens. Non-limiting examples of specific pathogens targeted by the fungicide composition include: Botrytis cinerea (i.e., Botrytis bunch rot, gray mold, Botrytis blight), Phomopsis viticola (i.e., Phomopsis cane and leaf spot), Phomopsis rachis, Phomopsis vaccinii (i.e., Phomopsis twig blight and canker), downy mildew, Sphaerotheca macularis (i.e., powdery mildew), Guignardia bidwellii (i.e., black rot), Monilinia vacinii-cormbosi (i.e., mummy berry), Phragmidium sp. (i.e., yellow rust), Drepanopeziza sp. (i.e., anthracnose), Kuehneola sp. (i.e., cane and leaf rust), Sphaerulina sp. (i.e., orange rust), Arthuriomyces sp. (i.e., powdery mildew), Mycosphaerella sp. (leaf spot), Colletotrichum acutatum (i.e., anthracnose fruit rot), Verticillium albo-atrum (i.e., Verticillium wilt), Phytophthora fragariae (i.e., red stele root rot), Dendrophoma obscurans (i.e., stem end rot, leaf blight), Phytophthora cactorum (i.e., leather rot), Diplocarpon earliana (i.e., leaf scorch), Godronia cassandrac (i.e., fusicoccum canker), Alternaria sp. (i.e., Alternaria fruit rot), Exobasidium vaccinii (i.e., red leaf disease), Microsphaera vaccinii (i.e., powdery mildew), Venturia inaegualis (i.e., apple scab), Gymnosporangium sp. (i.e., apple rust), Podosphaera leucotricha (i.e., apple powdery mildew), black rot of apple, blossom end rot of apple, blue mold of apple, brown rot of stone fruit, Rhizopus sp., Leucostoma cincta or Leucostoma persoonii (i.e., cytospora canker of stone fruits), white rot of apple, Monilinia fructicola (i.e., brown rot of stone fruit), Blumeriella jaapii (i.e., cherry leaf spot of stone fruit), sooty mold of pear, pear leafspot, pear leaf blight and fruit spot, Pythium ultimatum, Phytophthora infestans (late blight, potatoes), Aspergillus sp. (i.e., Aspergillus paraciticus), Apiosporina morbosa (i.e., black knot of stone fruit), Rhizoctonia solani (i.e., black scurf in potatoes, aerial blight, soybeans), Alternaria solani (early blight, potatoes), Sclerotium rolfsii (i.e., Sclerotium rot, sugar beets), Fusarium sp., Septoria sp. and white mold in soybeans and the like.

According to an embodiment of the present invention, the agrochemical composition is used as fungicide.

According to an embodiment, there is provided use of the agrochemical composition for controlling phytopathogenic fungal diseases, the composition comprising: a) at least one pyrazolecarboxamide fungicide or a derivative thereof; b) at least two surfactants comprising aryl sulphonic acid salts or its derivatives; and c) optionally at least one agrochemically acceptable excipient thereof, as a fungicide.

In another embodiment, the composition further comprises at least one or more additional fungicides selected from the group comprising dithiocarbamate fungicide and conazole fungicide.

According to an embodiment of the present invention, the agrochemical composition comprises fluindapyr or a derivative thereof and at least two surfactants, is used as fungicide.

According to an embodiment of the present invention, the agrochemical composition comprises bixafen or a derivative thereof and at least two surfactants, is used as fungicide.

According to an embodiment of the present invention, the agrochemical composition comprises fluindapyr or a derivative thereof, one or more additional fungicide or derivatives thereof and at least two surfactants is used as fungicide.

According to an embodiment of the present invention, the agrochemical composition comprises bixafen or a derivative thereof, one or more additional fungicide or derivatives thereof and at least two surfactants is used as fungicide.

According to an embodiment of the present invention, the agrochemical composition comprises fluindapyr or a derivative thereof, mancozeb, prothioconazole and at least two surfactants is used as fungicide.

According to an embodiment of the present invention, the agrochemical composition comprises bixafen or a derivative thereof, mancozeb, prothioconazole and at least two surfactants is used as fungicide.

According to an embodiment of the present invention, a kit comprising agrochemical composition is provided. The kit comprises a plurality of components, each of which components may include at least one or more of the ingredients of the agrochemical composition of the present invention.

According to an embodiment of the present invention, a kit comprises:
(a) at least one pyrazolecarboxamide fungicide or a derivative thereof; and
(b) at least one or more additional fungicide or a derivative thereof.

According to an embodiment of the present invention, a kit comprises:
(a) at least one pyrazolecarboxamide fungicide or a derivative thereof;
(b) at least one or more additional fungicide or a derivative thereof; and
(c) at least two surfactants comprising aryl sulphonic acid salts or its derivatives.

According to an embodiment of the present invention, a kit comprises:
(a) at least one pyrazolecarboxamide fungicide or a derivative thereof;
(b) at least one or more additional fungicide selected from a conazole, dithiocarbamate, benzimidazole, strobilurins and a copper group of fungicides or a derivative thereof; and
(c) at least two surfactants comprising aryl sulphonic acid salts or its derivatives.

According to an embodiment of the present invention, a kit comprises:
(a) at least one pyrazolecarboxamide fungicide selected from fluindapyr or bixafen;
(b) at least one or more additional fungicide selected from a conazole fungicide or a dithiocarbamate fungicide;
(c) at least two surfactants comprising aryl sulphonic acid salts or its derivatives thereof; and
(d) optionally at least one agrochemically acceptable excipient.

In one embodiment of the present invention, the kits may include one or more, including all, components that may be used to prepare the agrochemical composition. E.g., kits may include pyrazolecarboxamide fungicide, one or more additional fungicide and at least two surfactants comprising at least two salts of aryl sulphonic acid or its derivatives. One or more of the components may already be combined or pre-formulated. In those embodiments where more than two components are provided in a kit, the components may already be combined and as such are packaged in a single container such as a vial, bottle, can, pouch, bag or canister.

In view of the above, it will be seen that the several advantages of the disclosure are achieved, and other advantageous results attained. Although the present disclosure has been disclosed in full, it will be understood that numerous additional modifications and variations could be made thereto without departing from the scope of the disclosure. The embodiments may be combined together for better understanding of the disclosure, without departing from the scope of the disclosure.

It will be understood that the specification and examples are illustrative but not limitative of the present invention and that other embodiments within the spirit and scope of the invention will suggest themselves to those skilled in the art. Other embodiments can be practiced that are also within the scope of the present invention. The following examples illustrate the invention, but by no means intend to limit the scope of the claims.

### Examples

### Example 1: Fluindapyr 50% w/w WDG

| Ingredients | Quantity (% w/w) |
|---|---|
| Fluindapyr | 51.55 |
| Sodium diisopropylenenaphthalene | 4.00 |
| sulphonate | |
| Naphthalenesulphonic acid-formaldehyde | 4.00 |
| condensate, sodium salt | |
| Antifoam | 1.00 |
| Binder | Q.S. |
| Total | 100.00 |

### Process:

4 g Naphthalenesulphonic acid-formaldehyde condensate sodium salt and 4 g Sodium diisopropylenenaphthalene sulphonate were mixed with water to form homogeneous mixture. Separately, 51.55 g fluindapyr was mixed with water and milled to obtain particle size ranging between 8-10 μm. Milled fluindapyr was added to the homogenous mixture followed by addition of 1 g antifoam and binder. Remaining water was added to obtain slurry with 50% solids. The slurry was subjected to spray drying to obtain granules. Granules were dried at 60° C. for 60 min to get moisture content of final product less than about 2%.

### Example 2: Mancozeb 525 g/L+Prothioconazole 44 g/L+Fluindapyr 35 g/L WDG

| Ingredients | Quantity (% w/w) |
|---|---|
| Fluindapyr | 3.73 |
| Mancozeb | 62.00 |
| Prothioconazole | 4.75 |
| Sodium diisopropylenenaphthalene | 4.00 |
| sulphonate | |
| Naphthalenesulphonic acid- | 4.00 |
| formaldehyde condensate, sodium salt | |
| Antifoam | 1.50 |
| Binder | Q.S. |
| Total | 100.00 |

### Process:

4 g Sodium diisopropylenenaphthalene sulphonate, 4 g naphthalenesulphonic acid-Formaldehyde condensate, sodium salt was mixed in water in a vessel under stirring to get homogeneous mixture. Separately, 3.73 g fluindapyr and 4.75 g prothioconazole were mixed with water and was taken for bead milling to obtain mill-base with particle size D₉₀<10μ. The mill-base was then added to the homogeneous mixture followed by addition of 62 g mancozeb and 1.50 g antifoam under stirring followed by addition of water to obtain slurry with 50% solid content. The slurry was subjected to spray drying with inlet temperature between 90 to 120° C. and outlet temperature of 55° C. The granules thus obtained were dried on fluidized bed dryer at 60° C. for 60 min to get moisture content of final product less than about 2%.

### Example 3: Mancozeb 525 g/L+Prothioconazole 44 g/L+Bixafen 35 g/L WDG

| Ingredients | Quantity (% w/w) |
|---|---|
| Mancozeb | 61.62 |
| Prothioconazole | 4.60 |
| Bixafen | 3.67 |
| Napthalenesulphonic acid - | 4.00 |
| Formaldehyde condensate, sodium salt | |
| Sodium diisopropylenenaphathalene | 2.00 |
| sulphonate | |
| Emulsion of Polysiloxane | 1.5 |
| | 25 |
| Binder | Q.S. |
| Total | 100.00 |

### Process:

The formulation is prepared by following the process given in Example 1.

### Example 4: Mancozeb 525 g/L+Prothioconazole 44 g/L+Fluindapyr 35 g/L WDG (Comparative Composition)

| Ingredients | Quantity (% w/w) |
|---|---|
| Mancozeb tech (Purity: 86%) | 61.60 |
| Prothioconazole tech (Purity: | 4.70 |
| 98%) | |
| Fluindapyr tech (Purity: 98%) | 3.70 |
| Napthalenesulphonic acid - | 4.0 |
| Formaldehyde condensate, | |
| sodium salt | |
| Emulsion of Polysiloxane | 1.00 |
| Binder | Q.S. |
| Total | 100.00 |

### Example 5: Mancozeb 525 g/L+Prothioconazole 44 g/L+Fluindapyr 35 g/L WDG (Comparative Composition)

| Ingredients | Quantity (% w/w) |
|---|---|
| Mancozeb | 61.60 |
| Prothioconazole | 4.70 |
| Fluindapyr | 3.70 |
| Sodium | 4.0 |
| diisopropylenenaphathalene | |
| sulphonate | |
| Emulsion of Polysiloxane | 1.50 |
| Binder | Q.S. |
| Total | 100.00 |

### Example 6: Evaluation of Physiochemical Parameters

The composition of Example 2 was evaluated for various physicochemical parameters. Spray dried granules appeared as Greyish yellow colour granules free from extraneous matter and remained as such in accelerated heat storage (AHS) study conducted at 54° C. for 14 days. The active content of all the three active ingredients, i.e., fluindapyr, prothioconazole and mancozeb remained quite stable. Suspensibility of fluindapyr was found to be around 90.6%, suspensibility of prothioconazole as 91.2% and suspensibility of mancozeb to be 85.4% which was quite acceptable for the composition of the present invention. Moisture content remained less than about 2% in both ambient as well as AHS. The granules of the composition exhibited excellent wettability profile with wetting time as 3 seconds in ambient and 8 seconds in AHS. (Table 1)

TABLE 1
Evaluation of physiochemical parameters for Example 2

| Sr. | | | 14 D AHS |
|---|---|---|---|
| No. | Parameters | Ambient | @54° C. |
| 1 | Description (Visual | Greyish yellow color | Complies |
| | observation) | granules free from | |
| | | extraneous matter. | |
| 2 | Active content (% w/w) | | |
| | Mancozeb | 528.6 | 526.9 |
| | Prothioconazole | 46.6 | 46.2 |
| | Fluindapyr | 36.9 | 37.6 |
| 3 | Suspensibility Active (% w/w) | | |
| | Mancozeb | 85.40 | 81.88 |
| | Prothioconazole | 91.20 | 83.38 |
| | Fluindapyr | 90.60 | 82.22 |
| 4 | Moisture Content (% | 1.70 | 1.72 |
| | w/w) (LOD) | | |
| 5 | pH (1% aqueous | 6.04 | 6.12 |
| | dispersion) | | |
| 6 | Wettability (seconds) | 3 | 8 |

The composition of Examples 4 and 5 were evaluated for various physicochemical parameters. Even though the active content of all the three active ingredients, i.e., fluindapyr, prothioconazole and mancozeb remained stable, composition as per Examples 4 and 5 wherein only one sulfonic acid salt is employed, a drastic drop in suspensibility was observed. (Tables 2 and 3)

TABLE 2
Evaluation of physiochemical parameters for Example 4

| | Measuring | | 14 D AHS |
|---|---|---|---|
| Parameters | Unit | Ambient | @54° C. |
| Description | Visual | Greyish yellow | Greyish yellow |
| | | color granules | color granules |
| | | free from | free from |
| | | extraneous | extraneous |
| | | matter. | matter. |
| Active content as | | | |
| 1. Mancozeb | g/kg | 522.6 | 518.1 |
| 2. Prothioconazole | | 47.8 | 47.3 |
| 3. Fluindapyr | | 40.5 | 40.3 |
| Suspensibility Active | | | |
| basis | | | |
| 1. Mancozeb | % w/w | 79.71 | 76.11 |
| 2. Prothioconazole | | 85.30 | 73.14 |
| 3. Fluindapyr | | 67.66 | 47.96 |

TABLE 3
Evaluation of physiochemical parameters for Example 5

| | Measuring | | 14 D AHS |
|---|---|---|---|
| Parameters | Unit | Ambient | @54° C. |
| Description | Visual | Greyish yellow | Complies |
| | | color granules | |
| | | free from | |
| | | extraneous | |
| | | matter. | |
| Active content as | | | |
| 1. Mancozeb | g/kg | 513.1 | 510.2 |
| 2. Prothioconazole | | 42.9 | 42.9 |
| 3. Fluindapyr | | 36.8 | 36.1 |
| Suspensibility | | | |
| Active basis | | | |
| 1. Mancozeb | % w/w | 68.19 | 56.11 |
| 2. Prothioconazole | | 98.83 | 99.9 |
| 3. Fluindapyr | | 87.82 | 85.39 |

Therefore, the inventors of the present invention successfully developed various agrochemical compositions in the form of spray dried granules of pyrazolecarboxamide fungicide, alone or in combination with other active ingredients using specific surfactant combination. The agrochemical compositions demonstrated excellent suspensibility and wettability upon dilution. The active ingredients were found to remain quite stable after preparation and even during storage studies. The pH of the composition remained quite stable. The present invention also demonstrated advantageous methods of controlling pests.

1. An agrochemical composition comprising:
a) at least one pyrazolecarboxamide fungicide or a derivative thereof; and
b) at least two surfactants comprising aryl sulphonic acid salts or its derivatives thereof.

2. The composition as claimed in claim 1, wherein the pyrazolecarboxamide fungicide is selected from the group comprising benzovindiflupyr, bixafen, flubeneteram, fluindapyr, fluxapyroxad, furametpyr, inpyrfluxam, isopyrazam, penflufen, penthiopyrad, pydiflumetofen, pyrapropoyne, sedaxane, or a derivative thereof.

3. The composition as claimed in claim 1, wherein the aryl sulphonic acid salts are selected from the group comprising alkyl aryl sulfonates having C1-10 alkyl groups, aryl sulfonate-formaldehyde condensate or alkyl aryl sulfonate-formaldehyde condensate having C1-10 alkyl groups.

4. The composition as claimed in claim 1, wherein the composition comprises from about 0.1% w/w to about 80% w/w pyrazolecarboxamide fungicide of total weight of the composition.

5. The composition as claimed in claim 1, wherein the composition comprises from about 0.1% w/w to about 30% w/w aryl sulphonic acid salts of total weight of the composition.

6. The composition as claimed in claim 1, further comprising:
at least one or more additional fungicide or a derivative thereof.

7. The composition as claimed in claim 6, wherein the additional fungicide is selected from the group comprising dithiocarbamate, conazole, benzimidazole, strobilurins, and a copper group of fungicides or derivatives thereof.

8. The composition as claimed in claim 7, wherein the dithiocarbamate fungicide is selected from the group comprising azithiram, manam, thiram, ziram, dazomet, mancopper, mancozeb, maneb, metiram, propineb, and zineb.

9. The composition as claimed in claim 7, wherein the conazole fungicide is selected from the group comprising azaconazole, bromuconazole, cyproconazole, diclobutrazol, difenoconazole, epoxiconazole, etaconazole, fenbuconazole, flusilazole, flutriafol, furconazole, hexaconazole, metconazole, myclobutanil, penconazole, propiconazole, prothioconazole, quinconazole, simeconazole, tebuconazole, tetraconazole, triticonazole, and uniconazole.

10. The composition as claimed in claim 7, wherein the benzimidazole fungicide is selected from the group comprising albendazole, benomyl, carbendazim, chlorfenazole, cypendazole, dimefluazole, fuberidazole, and thiabendazole; and wherein the strobilurins are selected from the group comprising azoxystrobin, fluoxastrobin, picoxystrobin, pyraoxystrobin, pyraclostrobin, pyrametostrobin, fenaminstrobin, metominostrobin, kresoxim-methyl, and trifloxystrobin; and wherein the copper group of fungicides are selected from the group comprising basic copper carbonate, basic copper sulfate, tribasic copper sulphate, copper glycinate, Bordeaux mixture, copper hydroxide, copper oxychloride, copper sulfate, cuprous oxide, and mancopper.

11. The composition as claimed in claim 6, wherein the composition comprises from about 0.1% w/w to about 90% w/w one or more additional fungicide of total weight of the composition.

12. A solid agrochemical composition comprising:
a) at least one fungicide selected from fluindapyr or bixafen;
b) mancozeb;
c) prothioconazole;
d) at least two aryl sulphonic acid salts or its derivatives thereof; and
e) optionally at least one agrochemically acceptable excipient thereof.

13. The composition as claimed in claim 12, wherein the solid composition is in a form of water dispersible granules (WDG).

14. A method of controlling phytopathogenic fungal diseases by applying to a plant or locus or plant propagation material thereof, an agrochemical composition comprising: (a) at least one pyrazolecarboxamide fungicide or a derivative thereof; (b) at least two surfactants comprising aryl sulphonic acid salts or its derivatives thereof; and (c) optionally at least one agrochemically acceptable excipient thereof.

15. The method as claimed in claim 14, wherein the composition further comprises at least one or more additional fungicides selected from the group comprising dithiocarbamate fungicide and conazole fungicide.

16. (canceled)

17. (canceled)
